(19) United States
(12) Patent Application Publication
(10) Pub. No.: US 2012/0288140 A1
(43) Pub. Date: Nov. 15, 2012

(54) METHOD AND SYSTEM FOR SELECTING A VIDEO ANALYSIS METHOD BASED ON AVAILABLE VIDEO REPRESENTATION FEATURES

(75) Inventors: ALEXANDER HAUPTMANN, Finleyville, PA (US); BOAZ J. SUPER, Westchester, IL (US)

(73) Assignees: CARNEGIE MELLON UNIVERSITY, PITTSBURGH, PA (US); MOTOROLA SOLUTIONS, INC., Schaumburg, IL (US)

(21) Appl. No.: 13/107,427

(22) Filed: May 13, 2011

(51) Int. Cl. G06K 9/00

(52) U.S. Cl. 382/103

(57) ABSTRACT

A method is performed for selecting a video analysis method based on available video representation features. The method includes: determining a plurality of available video representation features for a first video output from a first video source and for a second video output from a second video source; and analyzing the plurality of video representation features as compared to at least one threshold to select one of a plurality of video analysis methods to track an object between the first and the second videos.

### TECHNICAL FIELD

The technical field relates generally to video analytics and more particularly to selecting a video analysis method based on available video representation features for tracking an object across a field of view of multiple cameras.

### BACKGROUND

Systems and methods for tracking objects (e.g., people, things) have use in many applications such as surveillance and the analysis of the paths and behaviors of people for commercial and public safety purposes. In many tracking solutions, visual tracking with multiple cameras is an essential component, either in conjunction with non-visual tracking technologies or because camera-based tracking is the only option.

When an object visible in a field of view (FOV) of one camera is also visible in the FOV of another camera, it is useful to determine that a single physical object is responsible for object detections in each camera's FOV. Making this determination enables camera handoff to occur if an object is traveling between the fields of view of two cameras. It also reduces the incidence of multiple-counting of objects in a network of cameras.

Accordingly, tracking systems that use multiple cameras with overlapping or non-overlapping fields of view must enable tracking of a target across those cameras. This involves optionally determining a spatial and/or temporal relationship between videos from the cameras and also involves identifying that targets in each video correspond to the same physical target. In turn, these operations involve comparing representations of videos from the two cameras. Current art performs object tracking across multiple cameras in a sub-optimal way, applying only a single matching algorithm. A shortcoming of using a single matching algorithm is that the particular algorithm being used may not be appropriate for every circumstance in which an object is being tracked.

Thus, there exists a need for and system for video analysis, which addresses at least some of the shortcomings of past and present techniques and/or mechanisms for object tracking.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system diagram of a system that implements selecting a video analysis method based on available video representation features in accordance with some embodiments.

FIG. 2 is a flow diagram illustrating a method for selecting a video analysis method based on available video representation features in accordance with some embodiments.

FIG. 3 is a flow diagram illustrating a method for determining a spatial and/or temporal relationship between two cameras in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a method is performed for selecting a video analysis method based on available video representation features. The method includes: determining a plurality of video representation features for a first video output from a first video source and for a second video output from a second video source; and analyzing the plurality of video representation features as compared to at least one threshold to select one of a plurality of video analysis methods to track an object between the first and the second videos. The plurality of video analysis method can include, for example, a spatial feature (SF) matching method, a spatio-temporal feature (STF) matching method, or an alternative matching method. The STF matching method may be a motion-SIFT matching method or a STIP matching method. The SF matching method may be a SIFT matching method, a HoG matching method, a MSER matching method, or an affine-invariant patch matching method.

Those skilled in the art will realize that the above recognized advantages and other advantages described herein are merely illustrative and are not meant to be a complete rendering of all of the advantages of the various embodiments.

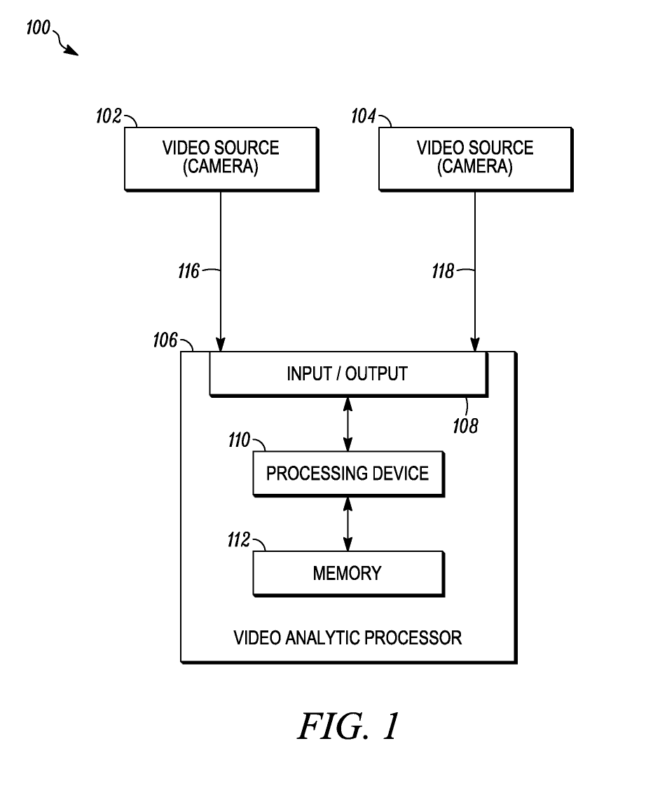

Referring now to the drawings, and in particular FIG. 1, a system diagram of a system that implements selecting a video analysis method based on available video representation features in accordance with some embodiments is shown and indicated generally at 100. System 100 includes a video source 102, a video source 104 and a video analytic processor 106. Only two video sources and one video analytic processor are included in system 100 for simplicity of illustration. However, the specifics of this example are merely illustrative of some embodiments, and the teachings set forth herein are applicable in a variety of alternative settings. For example, since the teachings described do not depend on the number of video sources or video analytic processors, the teachings can be applied to a system having any number of video sources and video analytic processors, which is contemplated and within the scope of the various teachings described.

Video sources 102 and 104 can be any type of video source that captures, produces, generates, or forwards, a video. As shown, video source 102 provides a video output 116 to the video analytic processor 106, and video source 104 provides a video output 118 to the video analytic processor 106. As used herein, a video output (or simply video) means a sequence of still images also referred to herein as frames, wherein the video can be real-time (streaming) video or previously recorded and stored (downloaded) video, and wherein the video may be coded or uncoded. Real time video means video that is captured and provided to a receiving device with no delays or with short delays, except for any delays caused by transmission and processing, and includes streaming video having delays due to buffering of some frames at the transmit side or receiving side. Previously recorded video means video that is captured and stored on a storage medium, and which may then be accessed later for purposes such as viewing and analysis.

As shown in FIG. 1, the video sources 102 and 104 are cameras, which provide real-time video streams 116 and 118 to the video analytic processor 106 substantially instantaneously upon the video being captured. However, in alternative implementations, one or both of the video sources 102 or 104 can comprise a storage medium including, but not limited to, a Digital Versatile Disc (DVD), a Compact Disk (CD), a Universal Serial Bus (USB) flash drive, internal camera storage, a disk drive, etc., which provides a corresponding video output comprising previously recorded video.

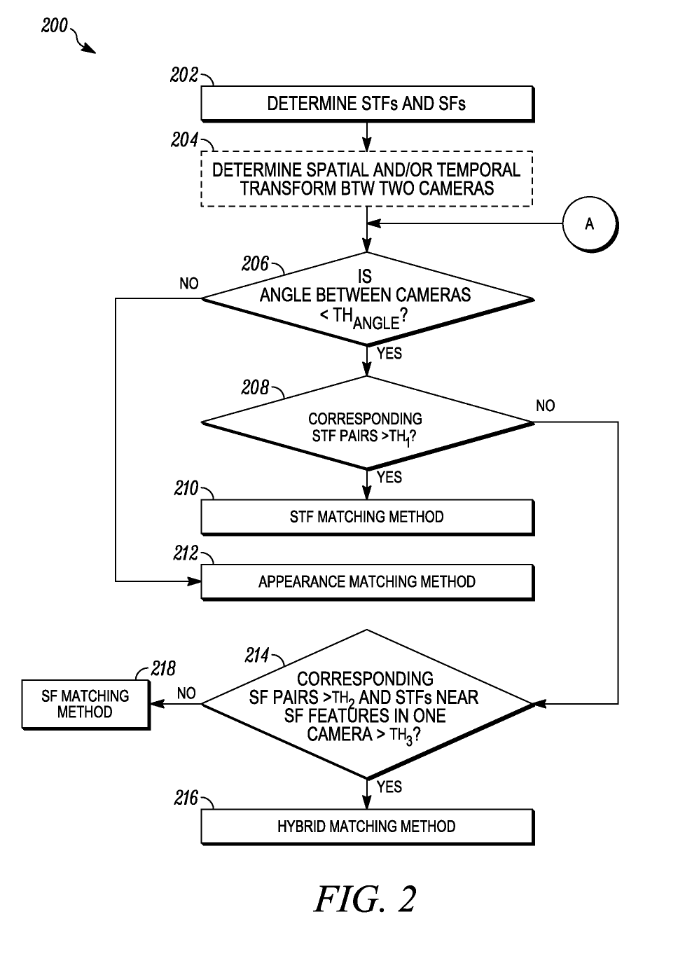

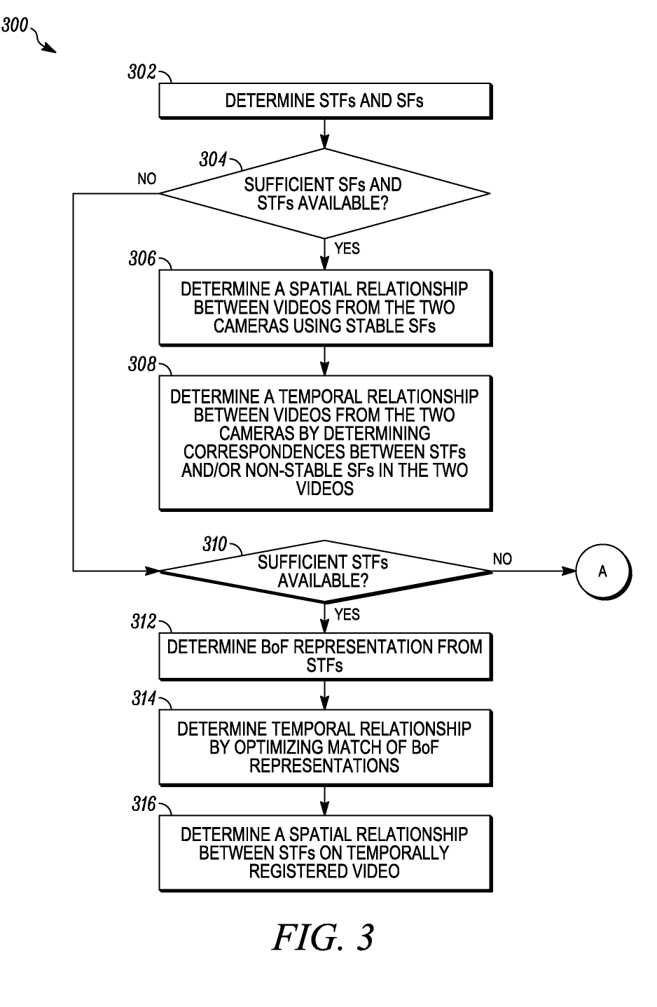

The video analytic processor 106 includes an input (and optionally an output) interface 108, a processing device 110, and a memory 112 that are communicatively and operatively coupled (for instance via an internal bus or other internetworking means) and which when programmed form the means for the video analytic processor 106 to implement its desired functionality, for example as illustrated by reference to the methods shown in FIG. 2 and FIG. 3. In one illustrative implementation, the input interface 108 receives the video 116 and 118 and provides these video outputs to the processing device 110. The processing device 110 uses programming logic stored in the memory 112 to determine a plurality of video representation features for the first video 116 and for the second video 118 and to analyze the plurality of video representation features as compared to at least one threshold to select one of a plurality of video analysis methods to track an object between the first and the second videos, for instance, as described in detail by reference to FIG. 2 and FIG. 3.

The input/output interface 108 is used at least for receiving a plurality of video outputs from a corresponding plurality of video sources. The implementation of the input/output interface 108 depends on the particular type of network (not shown), i.e., wired and/or wireless, which connects the video analytic processor 106 to the video sources 102, 104. For example, where the network supports wired communications (e.g., over the Ethernet), the input/output interface 108 may comprise a serial port interface (e.g., compliant to the RS-232 standard), a parallel port interface, an Ethernet interface, a USB interface, a FireWire interface, and/or other well known interfaces.

Where the network supports wireless communications (e.g., over the Internet), the input/output interface 108 comprises elements including processing, modulating, and transceiver elements that are operable in accordance with any one or more standard or proprietary wireless interfaces, wherein some of the functionality of the processing, modulating, and transceiver elements may be performed by means of the processing device through programmed logic such as software applications or firmware stored on the memory device of the system element or through hardware.

The processing device 110 may be programmed with software or firmware logic or code for performing functionality described by reference to FIG. 2 and FIG. 3; and/or the processing device may be implemented in hardware, for example, as a state machine or ASIC (application specific integrated circuit). The memory 112 can include short-term and/or long-term storage of various information (e.g., video representation features) needed for the functioning of the video analytic processor 106. The memory 112 may further store software or firmware for programming the processing device with the logic or code needed to perform its functionality.

As should be appreciated, system 100 shows a logical representation of the video sources 102 and 104 and the video analytic processor 106. As such, system 100 may represent an integrated system having a shared hardware platform between each video source 102, 104 and the video analytic processor 106. In an alternative implementation, the system 100 represents a distributed system, wherein the video analytic processor 106 comprises a separate hardware platform from both video sources 102 and 104; or a portion of the processing performed by the video analytic processor 106 is performed in at least one of the video sources 102 and 104 while the remaining processing is performed by a separate physical platform 106. However, these example physical implementations of the system 100 are for illustrative purposes only and not meant to limit the scope of the teachings herein.

Turning now to FIG. 2, a flow diagram illustrating a process for selecting a video analysis method based on available video representation features is shown and generally indicated at 200. In one implementation scenario, method 200 is used for object tracking between two video outputs from two different video sources. As used herein, object tracking means detecting movement of an object or a portion of the object (e.g., a person or a thing such as a public safety vehicle, etc.) from a FOV of one camera (as reflected in the video output (e.g., a frame of video) from the one camera) to a FOV of another camera (as reflected in the video output (e.g., a frame of video) from the other camera). The FOV of a camera is defined as a part of a scene that can be viewed through the lens of the camera. Object tracking generally includes some aspect of object matching or object recognition between two video output segments. At some points in time, if the cameras have overlapping fields of view, the object being tracked may be detected in the fields of view of both cameras. At other points in time the object being tracked may move completely from the FOV of one camera to the FOV of another camera, which is termed herein as a “handoff.” Embodiments of the disclosure apply in both of these implementation scenarios.

Moreover, in one embodiment, the process illustrated by reference to the blocks 202-218 of FIG. 2 is performed on a frame-by-frame basis such that a video analysis method is selected and performed on a single frame of one or both of the video outputs per iteration of the method 200. However, the teachings herein are not limited to this implementation. In alternative implementations, the method 200 is performed on larger or smaller blocks (i.e., video segments comprising one or more blocks of pixels) of video data.

Turning now to the particularities of the method 200, at 202, the video analytic processor 106 determines a plurality of video representation features for both video outputs 116 and 118, e.g., a frame 116 from camera 102 and a corresponding frame 118 from camera 104. The plurality of video representation features determined at 202 may include multiple features determined for one camera and none from the other; one video representation feature determined for each camera; one video representation feature from one camera and multiple video representation features from another camera; or multiple video representation features for each camera. Accordingly, the plurality of video representation features can comprise any combination of the following: a set of (i.e., one or more) spatio-temporal features for the first video, a set of spatial features for the first video, a set of appearance features for the first video, a set of spatio-temporal features for the second video, or a set of spatial features for the second video, or a set of appearance features for the second video.

A video representation feature is defined herein as a data representation for an image (or other video segment), which is generated from pixel data in the image using a suitable algorithm or function. Video representation features (which include such types commonly referred to in the art as interest points, image features, local features, and the like) can be used to provide a “feature description” of an object, which can be used to identify an object when attempting to track the object from one camera to another.

Examples of video representation features include, but are not limited to, spatial feature (SF) representations, spatio-temporal feature (STF) representations, and alternative (i.e., to SF and STF) data representations such as appearance representations. SF representations are defined as video representation features in which information is represented on a spatial domain only. STF representations are defined as video representation features in which information is represented on both a spatial and time domain. Appearance representations are defined as video representation features in which information is represented by low-level appearance features in the video such as color or texture as quantified, for instance, by pixel values in image subregions, or color histograms in the HSV, RGB, or YUV color space (to determine appearance representations based on color), and the outputs of Gabor filters or wavelets (to determine appearance representations based on texture), to name a few examples.

In an embodiment, SF representations are determined by detecting spatial interest points (SIPs) and then representing an image patch around each interest point, wherein the image patch representation is also referred to herein as a “local representation.” Examples of SIP detection methods include a Harris corner detection method, a Shi and Tomasi corner detection method, a Harris affine detection method, and a Hessian affine detection method. Examples of SF representations include a SIFT representation, a HoG representation, a MSER (Maximally Stable Extremal Region) representation, or an affine-invariant patch representation, without limitation.

For example, in one illustrative implementation, a scale-invariant feature transform (SIFT) algorithm is used to extract SF representations (called SIFT features), using, for illustrative example, open-source computer vision software, within a frame or other video segment. The SIFT algorithm detects extremal scale-space points using a difference-of-Gaussian operator; fits a model to more precisely localize the resulting points in scale space; determines dominant orientations of image structure around the resulting points; and describes the local image structure in around the resulting points by measuring the local image gradients, within a reference frame that is invariant to rotation, scaling, and translation.

In another illustrative implementation, a motion-SIFT (MoSIFT) algorithm is used to determine spatio-temporal features (STFs), which are descriptors that describe a region of video localized in both space and time, representing local spatial structure and local motion. STF representations present advantages over SF representations for tracking a moving object since they are detectable mostly on moving objects and less frequently, if at all, on a stationary background. A further example of an STF algorithm that could be used to detect STFs is a Spatio-Temporal Invariant Point (STIP) detector. However, any suitable STF detector can be implemented in conjunction with the present teachings.

A MoSIFT feature matching algorithm takes a pair of video frames (for instance from two different video sources) to find corresponding (i.e., between the two frames) spatio-temporal interest point pairs at multiple scales, wherein these detected spatio-temporal interest points have or are characterized as spatially distinctive interest points with “substantial” or “sufficient” motion as determined by a set of constraints. In the MoSIFT feature detection algorithm, the SIFT algorithm is first used to find visually distinctive components in the spatial domain. Then, spatio-temporal interest points are detected that satisfy a set of (temporal) motion constraints. In the MoSIFT algorithm, the motion constraints are used to determine whether there is a sufficient or substantial enough amount of optical flow around a given spatial interest point in order to characterize the interest point as a MoSIFT feature.

Two major computations are applied during the MoSIFT feature detection algorithm: SIFT point detection; and optical flow computation matching the scale of the SIFT points. SIFT point detection is performed as described above. Then, an optical flow approach is used to detect the movement of a region by calculating where a region moves in the image space by measuring temporal differences. Compared to video cuboids or volumes that implicitly model motion through appearance change over time, optical flow explicitly captures the magnitude and direction of a motion, which aids in recognizing actions. In the interest point detection part of the MoSIFT algorithm, optical flow pyramids are constructed over two Gaussian pyramids. Multiple-scale optical flows are calculated according to the SIFT scales. A local extremum from DoG pyramids can only be designated as a MoSIFT interest point if it has sufficient motion in the optical flow pyramid based on the established set of constraints.

Since MoSIFT interest point detection is based on DoG and optical flow, the MoSIFT descriptor also leverages these two features to, thereby, enable both essential components of appearance and motion information to be combined together into a single classifier. More particularly, MoSIFT adapts the idea of grid aggregation in SIFT to describe motions. Optical flow detects the magnitude and direction of a movement. Thus, optical flow has the same properties as appearance gradients in SIFT. The same aggregation can be applied to optical flow in the neighborhood of interest points to increase robustness to occlusion and deformation. The main difference to appearance description is in the dominant orientation. Rotation invariance is important to appearance since it provides a standard to measure the similarity of two interest points. However, adjusting for orientation invariance in the MoSIFT motion descriptors is omitted. Thus, the two aggregated histograms (appearance and optical flow) are combined into the MoSIFT descriptor, which has 256 dimensions. Similarly to the SIFT keypoints descriptors described above, multiple MoSIFT descriptors can be generated for an object and used as a point or means of comparison in order to track the object over multiple video outputs, for example.

Turning back to method 200 illustrated in FIG. 2, at 204 a spatial and/or temporal transform or relationship is optionally determined between the two cameras 102 and 104 using information contained in or derived from their respective video outputs 116 and 118. If function 204 is implemented, the selected spatial and/or temporal transform aligns the two images 116 and 118. The determination (204) of a spatial and/or temporal transform is described in detail below by reference to a method 300 illustrated in FIG. 3.

The remaining steps 206-218 of method 200 are used to select a video analysis method based on the available video representation features determined at 202. More particularly, at 206, it is determined whether an angle between the two cameras 102 and 104 is less than a threshold angle value, TH_{ANGLE}, which can be for instance 90° (since an angle between the two cameras that is greater than 90° would capture a frontal and a back view of a person, respectively). Accordingly, TH_{ANGLE} is basically used as a measure to determine whether the parts of a tracked object viewed in the two cameras are likely to have enough overlap where a sufficient number of corresponding SIFT or MoSIFT matches can be detected.

If the angle between the two cameras is at least greater than TH_{ANGLE}, then an alternative matching method that does not require the use of SF or STF representations is implemented, at 212. In such a case, the video representation features determined at 202 may yield no corresponding SFs and/or STFs between the two video inputs. For example, in one illustrative implementation, the alternative matching method is an appearance matching method. For instance, color-based matching could be used that has a slack constraint for different views. This can be done by extracting a color histogram of the tracked region in the frame output from the first camera and using mean shift to find the center of the most similar density distribution in the frame output from the second camera. However, the use of other appearance matching methods such as ones based on texture or shape are included within the scope of the teachings herein.

By contrast, if the angle between the two cameras is less than TH_{ANGLE}, the type and number of available video representation features are determined and compared to relevant thresholds. More particularly, at 208, when there is a set of STFs for each video, corresponding STF pairs are counted (e.g., determined from the sets of STFs features of both videos) and compared to a threshold, TH₁ to determine whether there are a sufficient number of corresponding pairs of STFs between the two frames. For example, feature X in image A is said to correspond to feature Y in image B if both X and Y are images of the same part of a physical scene, and correspondence is estimated by measuring the similarity of the feature descriptors, If the number of corresponding STF pairs exceeds TH₁, then an STF matching method is implemented, at 210. In one illustrative implementation, a MoSIFT matching (MSM) process is implemented, although any suitable STF matching method can be used depending on the particular STF detection algorithm that was used to detect the STFs. In an MSM process, the correspondence between the two cameras is first determined using MoSIFT features. More particularly, a χ² (Chi-square) distance is used to calculate the correspondence, which is defined in equation (1) as:

$$D ( {x}_{i} , {x}_{j} ) = \frac{1}{2} {\sum }_{t = 1}^{T} \frac{{( {u}_{t} - {w}_{t} )}^{2}}{{u}_{t} + {w}_{t}} \qquad ( 1 )$$

wherein xᵢ=(u₁, . . . , u_{T}) and xⱼ=(w₁, . . . , w_{T}), and wherein xᵢ and xⱼ are MoSIFT features. To accurately match between two the cameras, geometrically consistent constraints are added to the selection of correspondence pairs. Moreover, the RANSAC method of robust estimation is used to select a set of inliers that are compatible with a homography (H) between the two cameras. Assume w is the probability that a match is correct between two MoSIFT interest points; then the probability that the match is not correct is 1−wₛ where s is the size of samples we select to compute the H. The probability of finding correct parameters of H after n trials is: P(H)=1→(1−wₛ)ⁿ, which shows that after a large enough number of trials the probability of getting the correct parameters of H is very high, for instance where s=7. After doing a similarity match and RANSAC, a set of matched pairs which have both locally similar appearance and are geometrically consistent has been identified. A two-dimensional Gaussian function as shown in equation (2) is then used to model the distribution of these matched pairs,

$$P ( M ) = \frac{1}{{( 2 π )}^{\frac{k}{2}} {\vert E \vert}^{\frac{1}{2}}} exp ( - \frac{1}{2} {( M - μ )}^{′} {Σ}^{- 1} ( M - μ ) ) \qquad ( 2 )$$

where M denotes the coordinate value of the points, μ and Σ are the mean value and covariance matrix of M respectively. P(M) is used to establish a new bounding box for a tracked object

If the number of corresponding STF pairs fails to exceed TH₁, a further analysis is performed on the available video representation features, at 214, wherein the corresponding SF pairs and any STFs near SF representations in the frame from one of the cameras are counted (e.g., from sets of SF spatial features of both videos and a set of STFs from at least one of the videos) and compared, respectively to a threshold TH₂ and a threshold TH₃, to determine whether there is an insufficient number of STF representations in only one of the frames or in both of the frames. These two thresholds can be the same or different depending on the implementation. In the situation where the number of corresponding SF pairs exceeds TH₂, and the number of STFs near SF representations in the frame from one of the cameras exceeds TH₃ (which indicates that there is a sufficient number of STF representations in one of the frames being compared), then a hybrid matching method is selected and implemented, at 216. Otherwise, there is an insufficient number of STF representations in both of the frames. So an SF matching method is selected and implemented, at 218.

In one illustrative implementation, the SF matching (SM) method is a SIFT matching method, and the hybrid matching method (HBM) is a novel matching method that combines elements of both the SIFT and MoSIFT matching methods. Using the HBM, the MoSIFT algorithm extracts interest points with sufficient motion, as described above. But in some situations, such as in a nursing home, some residents walk very slowly, and it is sometimes hard to find sufficient motion points to determine the region in one image corresponding to object being tracked (in this example, the resident). The hybrid method combines both the MoSIFT and SIFT features for correspondence matching when the number of MoSIFT points from the frame of one camera is lower than the threshold TH₃. Because RANSAC is used to select inliers, TH₃ is set to 7. Straight SIFT feature detection is used instead of MoSIFT detection in the camera with low motion to find the correspondence. Since the MoSIFT features in the one camera are on the tracked person, the matched corresponding SIFT points in the second camera should also lie on the same object. Thus, no hot area need be set for selecting SIFT points in the second camera.

In the SM method, pure SIFT feature matching is used when the numbers of MoSIFT features in both cameras are both lower than the threshold TH₃. Different from MSM and HBM which succeed in MoSIFT detection on at least one camera to find an area of the tracked object, SM performs only SIFT detection on the frames from both cameras. SIFT detection cannot detect a specific object, since SIFT interest points may be found on the background as well as the object being tracked. Thus the detected interest points may be scattered around the whole image and can belong to any pattern in that image. Therefore, a “hot area” is defined a priori, indicating the limited, likely region that includes the tracked object in the frame from one camera, and then the corresponding SIFT points are located in the frame from other camera. Examples of methods for defining hot areas include, defining hot areas manually by an operator, or defining hot areas by another image analysis process, for example, one that detects subregions of the image that contain color values within a specified region of a color space.

Turning now to the details of functionality 204 (of FIG. 2) of determining a spatial and/or temporal transform or relationship between two cameras, which is described by reference to method 300 of FIG. 3. At 302, video representation features (e.g., SFs, STFs, etc.) are determined for one or more frames from the two cameras in the same manner as was described with respect to 202 of FIG. 2. Step 302 and step 202 may or may not be the same step.

At 304, the type of available video representation features are determined and counted. More particularly, when the type of features includes both STFs and stable SFs, the number of SFs and the number of STFs are counted in one or more frames of each video output. If the number of stable SFs in each video exceeds a suitable threshold and the number of STFs in each video exceeds a suitable threshold, for instance, as dictated by the methods and algorithms used to determine the temporal and/or spatial relationships in method 300, the method proceeds to 306 whereby a spatial relationship is determined between the two videos using stable SFs.

More particularly, at 306, for each video, it is determined which SFs are stable across multiple frames of that video. A “stable” SF means that the position of the SF remains approximately fixed over time. It does not have to be continuous however; and it is often the case that there will be some frames in which the SF is not detected, followed by other frames it which it is. Then, the spatial relationship between the stable SFs in one video and the stable SFs of the other video is determined by computing a spatial transformation. The spatial transformation may include, for example, a homography, an affine transformation, or a fundamental matrix.

Many methods for determining the spatial transformation are well known in the art. For example, some methods comprise determining correspondences between features in an image (video frame from one video) and another image (video frame from another video) and calculating a spatial transformation from those correspondences. In another example, some other methods hypothesize spatial transformations and select some transformations that are well supported by correspondences.

An illustrative and well-known example of a method for determining a spatial transformation is RANSAC. In RANSAC, samples of points are drawn using random sampling from each of two images; a mathematical transformation, which may be, for example, a similarity, affine, projective, or nonlinear transformation, is calculated between the sets of points in each image; and a number of inliers is measured. The random sampling is repeated until a transformation with a large number of inliers is found, supporting a particular transformation. Those skilled in the art will recognize that there are many alternative methods for determining a spatial transformation between images.

Once a spatial relationship has been determined, then a temporal relationship is determined, at 308, by determining correspondences between STFs and/or non-stable SFs and a temporal transformation between the two videos. In one embodiment, the temporal transformation is a one-dimensional affine transformation which is found together with the correspondences using RANSAC. In another embodiment, a search within a space of time shifts and time scalings may be executed and a time shift and scaling which results in a relatively high number of STFs and/or non-stable SFs from one video being transformed to be spatially and temporally near STFs and/or non-stable SFs of the other video will be selected to represent a temporal relationship between the videos. Those skilled in the art will understand that other methods for finding correspondences and transformations may also be used.

Turning back to 304, if the number of SFs is less than the corresponding threshold, method 300 proceeds to 310. At 310, if the number of STFs in each video is less than the threshold for STFs, method 300 returns to function 206 in FIG. 2. However, if the number of STFs in each video exceeds the corresponding threshold, the method proceeds to 312. At 312, a “Bag of Features” (BoF) (also called “Bag of Words”) representation is computed from STFs in one or more frames in each video using methods known to those skilled in the art of computer vision. For example, feature vectors of STFs may be clustered, using for example, k-means clustering or alternative clustering method to define clusters. The clusters and/or representatives of the clusters are sometimes called “words”. Histograms of cluster memberships of STFs in each video are computed. These are sometimes called “Bags of words” or “Bags of features” in the art.

At 314, a temporal relationship is determined by an optimizing match of the BoF representations. More specifically, histogram matching is performed between a histogram computed from one video and a histogram computed from another video. Those skilled in the art will recognize that different histogram matching methods and measures may be used. In one embodiment, a histogram intersection method and measure is used. For instance, in one illustrative implementation, histogram matching is performed for each of multiple values of temporal shift and/or temporal scaling, and a temporal shift and/or scaling that produces an optimum value of histogram match measure is selected to represent a temporal relationship between the two videos. In another illustrative implementation, the temporal relationship is represented by a different family of transformations, for example, nonlinear relationships may be determined by the method of comparing BoF representations between the two videos.

Finally, at 316, a spatial relationship between STFs of temporally registered videos (videos in which a temporal relationship determined in 314 is used to associate STFs from the two videos) is determined using methods for computing spatial relationships, for instance, using any of the methods described above with respect to 306 or any other suitable method.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for selecting a video analysis method based on available video representation features described herein. The non-processor circuits may include, but are not limited to, a radio receiver, a radio transmitter, signal drivers, clock circuits, power source circuits, and user input devices. As such, these functions may be interpreted as steps of a method to perform the selecting of a video analysis method based on available video representation features described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for selecting a video analysis method based on available video representation features, the method comprising:
determining a plurality of available video representation features for a first video output from a first video source and for a second video output from a second video source;
analyzing the plurality of video representation features as compared to at least one threshold to select one of a plurality of video analysis methods to track an object between the first and the second videos.

2. The method of claim 1, wherein the plurality of video analysis methods comprises a spatio-temporal feature matching method and a spatial feature matching method.

3. The method of claim 2, wherein the plurality of video analysis methods further comprises at least one alternative matching method to the spatio-temporal feature matching method and the spatial feature matching method.

4. The method of claim 3, wherein the at least one alternative matching method comprises at least one of a hybrid spatio-temporal and spatial feature matching method or an appearance matching method.

5. The method of claim 4, wherein the determined plurality of available video representation features is of a type that includes at least one of: a set of spatio-temporal features for the first video, a set of spatial features for the first video, a set of appearance features for the first video, a set of spatio-temporal features for the second video, or a set of spatial features for the second video, or a set of appearance features for the second video.

6. The method of claim 5 further comprising:
determining an angle between the two video sources and comparing the angle to a first angle threshold;
selecting the appearance matching method to track the object when the first angle is larger than the first angle threshold;
when the angle is less than the first angle threshold, the method further comprises:
determining the type of the plurality of available video representation features;
when the type of the plurality of available video representation features comprises the sets of spatio-temporal features for the first and second videos, the method further comprises:
determining from the sets of spatio-temporal features for the first and second videos a number of corresponding spatio-temporal feature pairs;
comparing the number of corresponding spatio-temporal feature pairs to a second threshold; and
when the number of corresponding spatio-temporal feature pairs exceeds the second threshold, selecting the spatio-temporal feature matching method to track the object;
when the type of the plurality of available video representation features comprises the sets of spatial features for the first and second video and the set of spatio-temporal features for the first or second videos, the method further comprises:
determining from the sets of spatial features for the first and second videos a number of corresponding spatial feature pairs and comparing the number of corresponding spatial feature pairs to a third threshold;
determining a first number of spatio-temporal features near the set of spatial features for the first video or a second number of spatio-temporal features near the set of spatial features for the second video, and comparing the first or second numbers of spatio-temporal features to a fourth threshold; and
when the number of corresponding spatial feature pairs exceeds the third threshold and the first or the second numbers of spatio-temporal features exceeds the fourth threshold, selecting the hybrid spatio-temporal and spatial feature matching method to track the object;
otherwise, selecting the spatial feature matching method to track the object.

7. The method of claim 4, wherein the hybrid spatio-temporal and spatial feature matching method comprises a motion-scale-invariant feature transform (motion-SIFT) matching method and a scale-invariant feature transform (SIFT) matching method.

8. The method of claim 2, wherein the spatio-temporal feature matching method comprises one of a motion-SIFT matching method or a Spatio-Temporal Invariant Point matching method.

9. The method of claim 2, wherein the spatial feature matching method comprises one of a scale-invariant feature transform matching method, a HoG matching method, a Maximally Stable Extremal Region matching method, or an affine-invariant patch matching method.

10. The method for claim 1, wherein the determining and analyzing of the plurality of video representation features is performed on a frame by frame basis for the first and second videos.

11. The method of claim 1 further comprising determining at least one of a spatial transform or a temporal transform between the first and second video sources.

12. The method of claim 11, wherein determining the at least one of the spatial transform or the temporal transform comprises:
determining a type of the plurality of available video representation features;
when the type of the plurality of available video representation features comprises both spatio-temporal features and spatial features, the method further comprising:
determining a spatial transformation using correspondences between stable spatial features; and
determining a temporal transformation between the first and second video by finding correspondences between the spatio-temporal features or non-stable spatial features for the first and second videos.
when the type of the plurality of available video representation features comprises spatio-temporal features but not spatial features, the method further comprising:
determining a Bag of Features (BoF) representation from the spatio-temporal features;
determining a temporal transformation by an optimizing match of the BoF representations; and
determining a spatial transformation between the spatio-temporal features on temporally registered video.

13. A non-transitory computer-readable storage element having computer readable code stored thereon for programming a computer to perform a method for selecting a video analysis method based on available video representation features, the method comprising:
determining a plurality of available video representation features for a first video output from a first video source and for a second video output from a second video source;
analyzing the plurality of video representation features as compared to at least one threshold to select one of a plurality of video analysis methods to track an object between the first and the second videos.
